(19) United States
(12) Patent Application Publication
(10) Pub. No.: US 2003/0160445 A1
(43) Pub. Date: Aug. 28, 2003

(54) Polymeric film structure having removable scratch-off layer

(76) Inventors: Robert M. Sheppard, Victor, NY (US); Jason Chaneske, Farmington, NY (US); Mark W Lockhart, Fairport, NY (US); JoAnn H. Squier, Bloomfield, NY (US)

Correspondence Address: EXXONMOBIL CHEMICAL COMPANY, P O BOX 2149, BAYTOWN, TX, 77522-2149, US

(21) Appl. No.: 10/083,953

(22) Filed: Feb. 27, 2002

(51) Int. Cl. B42D 15/00

(52) U.S. Cl. 283/100

(57) ABSTRACT

A polymeric film structure having a removable scratch off layer particularly suitable for use on “scratch and reveal” devices including instant lottery tickets, “scratch and win” game cards, and various other promotional items. The film structure includes an opaque cavitated layer secured to an adjacent layer along a weakened interface. The cavitated layer initially conceals certain preprinted indicia, e.g., prize information, but may be subsequently removed by scratching and/or rubbing to allow viewing of such indicia.

### BACKGROUND OF THE INVENTION

The present invention relates to polymeric film structures and, more particularly, to a polymeric film structure having a removable scratch-off layer particularly suitable for use on “scratch and reveal” devices including instant lottery ticket, “scratch and win” game cards and various other promotional items.

Removable scratch-off coatings are well known from their use on instant lottery tickets and various “scratch and win” game cards. The popularity of such lottery tickets and game cards has grown significantly over the recent years, and continues to grow even larger. The typical instant lottery ticket and/or game card utilizes a paper-based substrate upon which certain prize information and other graphics are printed. The prize information and graphics are thereafter coated with one or more layers of an overprint varnish (e.g., a UV curable coating) to protect the printing. The prize information is then covered with several coatings of an opaque ink, such process typically requiring multiple passes through the printing station and/or multiple printing stations. Alternatively, a metallic wax coating or other opaque metal-based coating may be used to hide the prize information.

It will be appreciated by those skilled in the art that the manufacturing process used to produce currently-available “instant-type” lottery tickets and game cards requires multiple printing steps and/or multiple printing stations, resulting in increased manufacturing costs. Moreover, these same manufacturing processes fail to provide the manufacturers with a great degree of flexibility in the design of the tickets/game cards. For example, because the opaque coatings used on today's “instant-type” lottery tickets and game cards are typically applied after the substrate is printed, the resultant ticket/game card will not include any printing on the outer surface of such opaque coatings. This lack of printing limits the design and layout of the ticket/game card, and reduces the overall esthetic appeal of such ticket/game card. Of course, it will be recognized that many of the opaque coatings used on today's tickets/game cards are not even capable of receiving print.

It would therefore be desirable to provide a structure having a removable scratch-off layer suitable for use on various “scratch and reveal” devices, the structure being more readily manufactured and providing greater degrees of flexibility in the design parameters of the final product including the application of print over the opaque removable portions thereof.

### SUMMARY OF THE INVENTION

The present invention, which addresses the needs of the prior art, is directed to a polymeric film structure having a removable layer. The film structure includes a transparent base layer having first and second surfaces. The first surface of the base layer is adapted for placement of indicia thereon. The film structure further includes a cavitated layer having first and second surfaces. The first surface of the cavitated layer is adhered to the second surface of the base layer along a first interface. Finally, the film structure includes a skin layer having first and second surfaces. The first surface of the skin layer is adhered to the second surface of the cavitated layer. The second surface of the skin layer is adapted for printing thereon. The cavitated layer is cavitated to a degree sufficient to limit viewing of the base layer therethrough and to a degree sufficient to weaken the first interface and allow the cavitated layer to be removed from the base layer. The skin layer is formed with a thickness sufficient to protect the cavitated layer during handling while allowing subsequent removal of the cavitated layer.

The present invention further relates to a method of manufacturing a “scratch and reveal” device having a removable scratch-off layer. The method includes the step of co-extruding a multilayer polymeric film structure, the film structure including a base layer having first and second surfaces; a core layer having first and second surfaces and including a predetermined amount of a cavitating agent; and a skin layer having first and second surfaces. The first surface of the core layer is adhered to the second surface of the base layer along a first interface, while the first surface of the skin layer is adhered to the second surface of the core layer. The method includes the further step of stretching the film structure to cavitate the core layer to a degree sufficient to weaken the first interface and allow the cavitated layer to subsequently be scratched away from said base layer. Finally, the method includes the step of securing indicia to the first surface of the base layer whereby the indicia is viewable through the base layer only upon removal of the cavitated layer therefrom.

As a result, the present invention provides a polymeric film structure having a removable scratch-off layer suitable for use on “scratch and reveal” devices such as instant lottery tickets, “scratch and win” game cards or other promotional items. The device can be readily manufactured, and provides increased flexibility in the design parameters of the final product including the application of print over the opaque removable portions thereof.

### BRIEF DESCRIPTION OF THE DRAWINGS

FIG. 1 shows a three layer co-extruded polymeric film structure having a removable scratch-off layer;

FIG. 2a shows the film structure of FIG. 1 having indicia on the outer surface of the base layer, the indicia being covered by a layer of opaque ink;

FIG. 2b shows the film structure of FIG. 1 having indicia on the outer surface of the base layer, the indicia being covered by an opaque substrate; and

FIG. 2c shows the film structure of FIG. 1 having a separate opaque substrate laminated to the outer surface of the base layer, the substrate including indicia on the inner surface thereof.

### DETAILED DESCRIPTION OF THE INVENTION

It has been discovered herein that a removable scratch-off layer can be incorporated into polymeric film structures having multiple extruded layers, and that such structures can thereafter be used to produce “scratch and reveal” devices including instant lottery tickets, “scratch and win” game cards and various promotional items. The removable scratch-off layer can also be incorporated into existing packaging and labels, thus allowing a manufacturer the opportunity to conduct a promotional and/or marketing campaign through the sale and distribution of an existing product. As will be discussed further hereinbelow, the “scratch and reveal” devices produced in accordance with the present invention can be manufactured at a reduced cost as compared to conventional tickets/game cards due to the novel structures described herein and the overall advantages associated with production of polymeric films. Moreover, the processes used to produce such “scratch and reveal” devices provides increased flexibility in the overall design of such products.

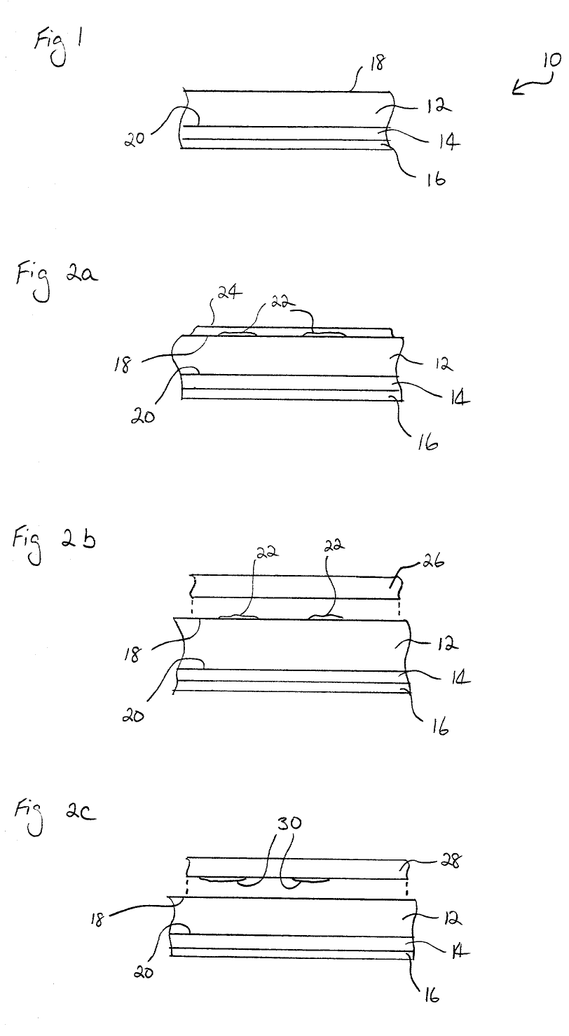

Referring now to FIG. 1, the present invention is directed to a polymeric film structure 10, preferably formed by simultaneously co-extruding a plurality of discrete layers, e.g., layers 12, 14 and 16. As shown, film structure 10 includes a base layer 12, a cavitated layer 14 and a skin layer 16. As will be appreciated by those skilled in the art, layer 14 becomes cavitated upon orientation of the film structure following extrusion of the layers. This cavitation results from the incorporation of a cavitating agent (such as calcium carbonate) into layer 14. The process of simultaneously extruding multiple layers, and thereafter orienting the extruded structure (which causes cavitation of any layer including a cavitating agent) is well known in the art. It has been discovered herein that a cavitated layer, when properly designed and incorporated into a polymeric film structure, can function as a removable scratch-off layer which initially hides indicia placed behind an adjacent layer. The term indicia as used herein refers to printed words, numbers and/or graphics which are initially intended to be hidden from view, and which are only viewable upon removal of the scratch-off layer. This indicia may include various forms of prize, promotional and/or marketing information.

Referring again to FIG. 1, base layer 12 is formed as a transparent layer so that surface 18 can be viewed when looking through the base layer from surface 20. As a result, indicia placed on surface 18 of base layer 12 can be read when viewed through the base layer from surface 20. Of course, such indicia cannot be initially viewed from surface 20 because of the presence of cavitated layer 14, which is opaque due to the cavitation of such layer. Opaque additives, such as TᵢO₂, can also be added to the cavitated layer (and to other layers of the film structure) to increase the opacity of such layers and prevent attempts to view the hidden indicia.

It will be appreciated that the indicia applied to surface 18 of base layer 12 is typically covered in some manner so that such indicia cannot be seen when viewed from that same side of the structure. For example, indicia 22 applied to surface 18 of base layer 12 can be covered by a layer of opaque ink 24 (see FIG. 2a) and/or an opaque substrate 26 can be laminated over indicia 22 (see FIG. 2b). Alternatively, an opaque substrate 28 including indicia 30 can be laminated to surface 18 of base layer 12 (see FIG. 2c).

Once the indicia is applied to surface 18 of base layer 12 and covered to prevent viewing from that side of the base layer, the indicia can only be read upon removal of cavitated layer 14 (and skin layer 16) from structure 10. In this regard, it has been discovered herein that cavitated layer 14 can be designed in such a manner as to provide sufficient opaqueness to prevent viewing of the indicia placed on surface 18 of base layer 12, yet be capable of being removed (e.g., via scratching) from film structure 10. Particularly, such factors as the thickness of layer 14, the amount of cavitating agent added to layer 14, and the degree of orientation of film structure 10 can be carefully chosen to provide a structure wherein the interface between cavitated layer 14 and base layer 12 is inherently weak thereby allowing the cavitated layer to be subsequently removed from film structure 10 when such cavitated layer is “rubbed” or “scratched”. The removal of layer 14 should be achievable with minimal effort (i.e., through the use of a fingernail or coin) and be accomplished without damaging base layer 10 (which could prevent/hinder viewing of the hidden indicia).

In one preferred embodiment, the cavitated layer is formed from a polyolefin such as polypropylene, and a cavitating agent such as calcium carbonate with a range of from about 8% to about 50% by weight, and preferably from about 15% to about 30% by weight. The amount of cavitating agent necessary to cause the desired degree of cavitation is based in part on the particle size and range of the cavitating agent. One preferred material has an average particle size of 2 microns and a range of 1-10 microns. It will be appreciated that using a cavitating agent with a smaller particle size and/or narrower range may require that greater amounts of such material be used to achieve the same degree of cavitation of layer 14. Of course, other cavitating agents are contemplated herein.

Following extrusion of the discrete layers, the structure is stretched from about 3 to about 7 times in the machine direction and from about 3 to about 12 times in the transverse direction and, preferably from about 4 to about 6 times in the machine direction and from about 7 to about 9 times in the transverse direction. The cavitated layer has an optical thickness of from about 0.5 mils to about 3 mils and, preferably from about 1 mil to about 2 mils. It will be appreciated that structure 10 can include more than one cavitated layer provided the multiple cavitated layers may be readily removed via “rubbing” or “scratching”.

Film structure 10 preferably includes a skin layer 16 which has a thickness sufficient to protect the cavitated layer during handling, but which allows subsequent removal of the cavitated layer. The material used to form the skin layer must be sufficiently soft as to not hinder the subsequent scratch-off capability of the cavitated layer, but not too soft as to allow damage to the cavitated layer during handling. It is contemplated that skin layer 16 can be formed from various polyolefins. Preferred materials for manufacture of the skin layer include propylene-ethylene copolymers, propylene-ethylene-butylene terpolymers and medium density polyethylene. The skin layer has a thickness of from about 0.02 mils to about 0.1 mils and, preferably a thickness of from about 0.03 mils to about 0.05 mils.

The skin layer also provides a smooth surface for printing. In this regard, the mentioned propylene-ethylene copolymer, propylene ethylene-butylene terpolymer and medium density polyethylene are well adapted for receipt of printing. Particularly, graphics including marketing/promotional material and/or instructions associated with “playing” the “scratch and reveal” device can be printed on the skin layer. In fact, printing can be applied directly over areas which will subsequently be removed. Currently available tickets/game cards typically do not allow for printing over the areas of the ticket containing the opaque coating. This ability to print anywhere on the skin layer enhances the overall aesthetic appeal of the “scratch and reveal” device and provides greater flexibility with respect to the design of such devices.

The base layer, which is transparent to allow viewing of the indicia therethrough, can be formed from a single extruded layer, or from a plurality of discrete extruded layers. One particularly preferred material for forming the base layer is a polyolefin such as polypropylene. In one particular preferred embodiment, the base layer is formed as a clear layer of polypropylene. In another preferred embodiment, the base layer is tinted or otherwise modified to visibly effect the passage of light therethrough. The modified base layer can then be used in conjunction with a preselected ink and/or particular printing process which allows reading of the indicia only when viewed through the modified base layer.

The base layer, in the absence of any additional substrate, must be sufficiently thick to provide the lottery ticket/game card with the necessary strength and thickness for functionality. In those embodiments wherein a separate substrate is laminated to the extruded film structure, the overall stiffness/strength of the base layer may be of less importance. In one preferred embodiment, the base layer has a minimum thickness of from about 0.3 mils to about 0.5 mils.

In practice, the “scratch and reveal” devices produced in accordance with the present invention are made by simultaneously co-extruding a multi-layer polymeric film structure wherein a cavitating agent has been added to at least one layer, and thereafter orienting the structure to cavitate the layer containing the agent thereby rendering such layer opaque. An additional opacifying agent can be added to the cavitated layer, or to another layer of the structure, to increase the overall opacity of the protective coating. Indicia is then applied to the outer surface of the base layer, either by laminating thereto a substrate already containing the indicia or by printing the indicia directly on the surface of the base layer and thereafter covering such indicia with a layer of opaque material (e.g., an opaque substrate or a layer of opaque ink). Finally, printing can be applied to the skin layer, either before or after placement of the indicia on the outer surface of the base layer. The polymeric layer being printed upon can be pretreated via several known techniques to enhance the printability of such layer.

The following example is directed to a polymeric film structure having a removable scratch-off layer produced in accordance with the present invention.

### EXAMPLE

A multilayer polymer film structure was coextruded. The base layer, which was formed of several discrete layers of polypropylene (Exxon 4612), had an overall thickness of 1.23 mils. The adjacent layer, also formed of polypropylene (Exxon 4612), had a thickness of 0.15 mils and included 25% by weight of calcium carbonate having an average particle size of 2 microns and a range of 1-10 microns. The outer skin layer was formed of a propylene-ethylenebutylene terpolymer (Chisso 7510) having a thickness of 0.03 mils. The extruded structure was stretched approximately 5 times in the machine direction and approximately 7 times in the cross direction (providing a cavitated layer with an optical thickness of approximately 0.5 mils). Indicia was reverse printed on the outside surface of the base layer. A synthetic paper substrate was then laminated to the outer surface of the base layer, thereby covering (and “hiding”) the indicia.

The cavitated layer of the resultant structure, which initially obscured viewing of the indicia, was easily removed from the base layer by scratching with a fingernail or coin—thereby allowing viewing of the indicia printed on the outside surface of the base layer. The base layer was not damaged by the removal of the cavitated layer therefrom. The performance of the cavitated layer was similar to the wax coatings used in currently-available “instant type” lottery tickets and game cards.

It will be appreciated that the present invention has been described herein with reference to certain preferred or exemplary embodiments. The preferred or exemplary embodiments described herein may be modified, changed, added to or deviated from without departing from the intent, spirit and scope of the present invention, and it is intended that all such additions, modifications, amendments and/or deviations be included within the scope of the following claims.

What is claimed is:

1. A polymeric film structure having a removable layer, comprising:
a transparent base layer having first and second surfaces, said first surface of said base layer being adapted for placement of indicia thereon;
a cavitated layer having first and second surfaces, said first surface of said cavitated layer being adhered to said second surface of said base layer along a first interface;
a skin layer having first and second surfaces, said first surface of said skin layer being secured to said second surface of said cavitated layer, said second surface of said skin layer being adapted for printing thereon;
wherein said cavitated layer is cavitated to a degree sufficient to limit viewing of said base layer therethrough and to a degree sufficient to weaken said first interface and allow said cavitated layer to be removed from said base layer; and
wherein said skin layer is formed with a thickness sufficient to protect said cavitated layer during handling while allowing subsequent removal of said cavitated layer.

2. The film structure according to claim 1, wherein said cavitated layer includes from about 8% to 50% by weight of a cavitating agent.

3. The film structure according to claim 2, wherein said cavitated layer is formed from a polyolefin and has an optical thickness of from about 0.5 mils to about 3 mils, and wherein said cavitated layer may be scratched away from said base layer.

4. The film structure according to claim 3, wherein said cavitating agent is calcium carbonate having an average particle size of 2 microns and a range of 1 to 10 microns, and wherein said cavitated layer includes from about 15% to about 30% by weight of said calcium carbonate.

5. The film structure according to claim 1, wherein said skin layer is formed from a polyolefin and has a thickness of from about 0.02 mils to about 0.1 mils.

6. The film structure according to claim 5, wherein said skin layer is formed from a polymer selected from the group consisting of propylene-ethylene copolymers, propylene-ethylene-butylene terpolymers and medium density polyethylene, said skin layer having a thickness of from about 0.3 mils to about 0.05 mils.

7. The film structure according to claim 1, further comprising a substrate laminated to said first surface of said base layer, said indicia being printed on said substrate and viewable through said base layer.

8. The film structure according to claim 1, wherein said indicia is printed on said first surface of said base layer.

9. The film structure according to claim 8, further comprising a layer of opaque ink covering said indicia.

10. The film structure according to claim 1, wherein said indicia comprises prize information.

11. The film structure according to claim 1, wherein said base layer comprises a plurality of extruded layers.

12. The film structure according to claim 11, wherein said base layer is transparent and is formed from a polyolefin.

13. The film structure according to claim 1, wherein said base layer is modified to visibly effect the passage of light therethrough, and wherein said indicia is selected to be viewable through said modified base layer.

14. The film structure according to claim 13, wherein said modified base layer is tinted with a preselected color.

15. The film structure according to claim 1, wherein said film structure is stretched from about 3 times to about 7 times in the machine direction and from about 3 times to about 12 times in the transverse direction.

16. A method of manufacturing a “scratch and reveal” device having a removable scratch-off layer, comprising:
a) co-extruding a multilayer polymeric film structure, said structure including:
a base layer having first and second surfaces;
a core layer having first and second surfaces and including a predetermined amount of a cavitating agent, said first surface of said core layer being adhered to said second surface of said base layer along a first interface;
a skin layer having first and second surfaces, said first surface of said skin layer being adhered to said second surface of said core layer;
b) stretching said film structure to cavitate said core layer to a degree sufficient to weaken said first interface and allow said cavitated layer to subsequently be scratched away from said base layer; and
c) securing indicia to said first surface of said base layer whereby said indicia is viewable through said base layer only upon removal of the cavitated layer therefrom.

17. The method according to claim 16, wherein said securing step includes the steps of: providing a substrate having said indicia printed thereon and laminating said substrate to said first surface of said base layer.

18. The method according to claim 16, wherein said securing step includes the step of: printing said indicia on said first surface of said base layer and covering said indicia with at least one layer of an opaque material.

19. The method according to claim 16, further comprising the step of applying print to said skin layer.

20. The method according to claim 16, wherein said stretching step includes stretching said film structure from about 3 times to about 7 times in the machine direction and from about 3 times to about 12 times in the transverse direction.

21. The method according to claim 16, wherein said stretching step includes stretching said film structure from about 4 times to about 6 times in the machine direction and from about 7 times to about 9 times in the transverse direction.

22. The method according to claim 16, wherein said co-extruding step includes the step of modifying said base layer to visibly effect the passage of light therethrough.

23. The method according to claim 16, further comprising the step of scratching said cavitated layer away from said base layer thereby exposing said indicia.
